(19) United States
(12) Patent Application Publication
(10) Pub. No.: US 2015/0368596 A1
(43) Pub. Date: Dec. 24, 2015

(54) PERFORMANCE GEAR, TEXTILE TECHNOLOGY, AND CLEANING AND PROTECTING SYSTEMS AND METHODS

(71) Applicant: HEX Performance, LLC, Arnold, MD (US)

(72) Inventors: Drew Westervelt, Baltimore, MD (US); Doug Bradford, Severna Park, MD (US)

(21) Appl. No.: 14/743,758

(22) Filed: Jun. 18, 2015

Related U.S. Application Data
(60) Provisional application No. 62/013,673, filed on Jun. 18, 2014.

(51) Int. Cl. C11D 11/00; C11D 3/00

(52) U.S. Cl. CPC C11D 11/0017; C11D 3/0068; C11D 3/001; C11D 3/0036

(57) ABSTRACT

A cleaning system is available for cleaning at least one of high performance textiles, sports gear, and laundry. The cleaning system includes a washing agent and a protective agent. The washing agent is configured to remove unwanted matter from at least one of the high performance textiles, sports gear, and laundry. The protective agent is configured to create a bonded barrier of protection against odors from at least one of bacteria, mold and mildew. The washing agent and the protective agent are configured to be used in a two-step water-based treatment process in which the washing agent is provided in a given first step of the treatment process and the protective agent is provided in a given subsequent second step of the treatment process.

### REFERENCE TO PENDING PRIOR PATENT APPLICATION

This application claims the benefit under 35 U.S.C. 119 (e) of U.S. Provisional Patent Application No. 62/013,673, filed Jun. 18, 2014 by Drew Westervelt and Doug Bradford for “PERFORMANCE GEAR, TEXTILE TECHNOLOGY, AND CLEANING AND PROTECTING SYSTEMS AND METHODS,” which patent application is hereby incorporated herein by reference.

### BACKGROUND

It is a common know fact that soapy residues left in any textile will cause rapid re-soiling. Popular synthetic and synthetic blend high performance textiles/other materials used to manufacture apparel, gear and footwear present a special set of cleaning needs. These textiles/other materials are manufactured using more synthetic materials rather than cotton.

The re-soiling or entrapment of body oil, soil, bacteria and sweat can lead to unwanted odors being trapped in any textiles/other materials. However, research indicates the new high tech fabrics are not responding as well to traditional detergents. Furthermore, performance gear manufacturers generally recommend against the use of fabric softeners and dryer sheets. Many end users, though, use popular detergents, fabric softeners, and dryer sheets that may clog tiny moisture wicking perforations in textiles/other materials.

Synthetic fibers like polyester and olefin tend to have a natural affinity to oily and sticky residues. This is due to their chemical makeup, e.g., fiber polarity & surfactant polarity. Once soil and/or oil (sweat) is/are absorbed into and/or adsorbed onto one of these fibers or into a tight, perforated (breathable /moisture wicking) weave, special cleaning agents are needed to clean away these pollutants.

Most, if not all, currently available solutions offer only a deodorizing spray and sport branded laundry detergent. As such, there is a need for laundry system that will facilitate the cleaning of synthetic fabrics, such as those found in sports gear. Moreover, there is a further need for a laundry system that will not tend to degrade the wicking properties of such fabrics and/or that will impede the adsorption/absorption of odor-causing microbes onto such fabrics during their use.

### SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In an embodiment, there is provided a cleaning system for high performance textiles/other materials, the cleaning system includes a cleaning agent and a protective agent. The cleaning agent is configured to remove unwanted matter from at least one of the high performance textiles/other materials. The protective agent is configured to yield a long lasting bonded barrier of protection against odors from at least one of bacteria, mold and mildew. The protective agent may also exhibit anti-static and softening properties.

Other embodiments are also disclosed.

Additional objects, advantages and novel features of the technology will be set forth in part in the description which follows, and in part will become more apparent to those skilled in the art upon examination of the following, or may be learned from practice of the technology.

### BRIEF DESCRIPTION OF THE DRAWINGS

Non-limiting and non-exhaustive embodiments of the present invention, including the preferred embodiment, are described with reference to the following figures, wherein like reference numerals refer to like parts throughout the various views unless otherwise specified. Illustrative embodiments of the invention are illustrated in the drawing, in which:

FIG. 1 illustrates an exemplary embodiment of a cleaning system involving a two-step process employed within a water-based washing machine.

### DETAILED DESCRIPTION

Embodiments are described more fully below in sufficient detail to enable those skilled in the art to practice the system and method. However, embodiments may be implemented in many different forms and should not be construed as being limited to the embodiments set forth herein. The following detailed description is, therefore, not to be taken in a limiting sense.

Various embodiment of the cleaning systems and methods of the present disclosure are specially designed for high performance textiles/other materials. These the cleaning systems and methods are configured to break down and remove bio-loads that may otherwise provide breeding grounds for odors typically associated with bacteria, mold and mildew. Anti-static and anti-re-soiling properties are built into such cleaning systems, both simplifying the cleaning process of today's apparel, gear and footwear and increasing the effectiveness thereof.

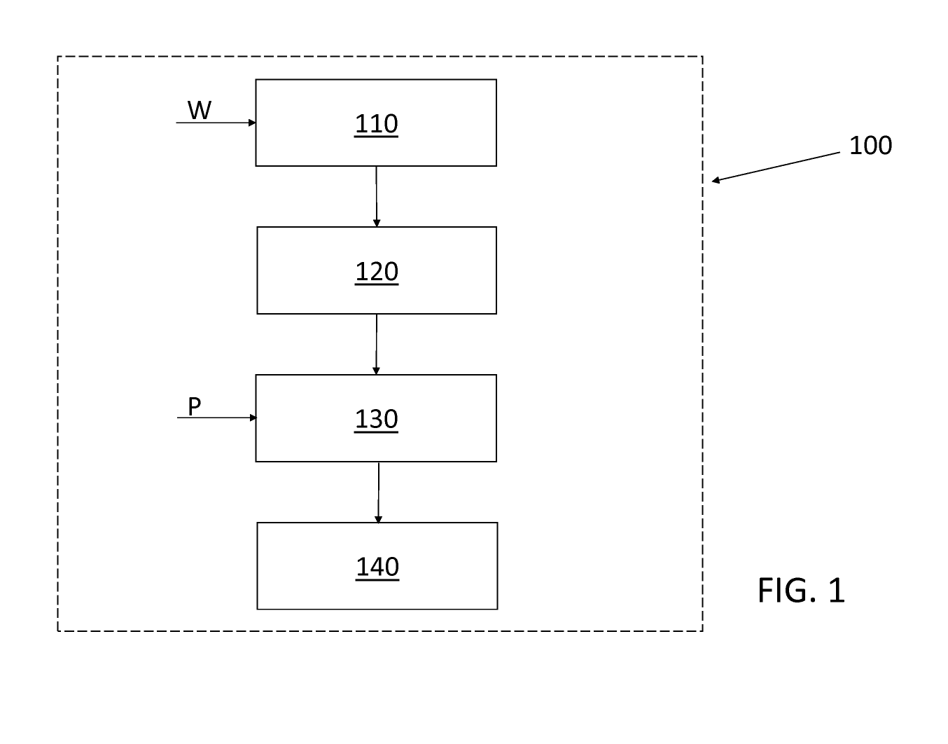

Referring to FIG. 1, the cleaning system and the related method involve a two-step process that utilizes a water-based washing machine 100. The water-based washing machine 100 may be in the form of a top-loading machine or a side-loading machine, as are commonly available. Furthermore, the water-based washing machine 100 may be a commercial or home-use version. A given washing machine 100 typically employs, in order, at least a washing cycle 110, a first spin cycle 120, a rinse cycle 130, and a second spin cycle 140, but it is to be understood that additional versions of such cycles may be employed, whether provided by the control system (not shown) of the washing machine 100 or manually incorporated by the user by resetting the controls as desired. Further, for the purposes of the present cleaning system, the key aspect is that the water-based washing machine 100 offers a given washing cycle 110 and a given rinse cycle 130, as those serve as points at which to introduce, respectively, the washing agent W and the protective agent P.

The present cleaning system and method, in one embodiment, first utilizes a premium washing or cleaning agent W, which is introduced during the washing cycle 110. It is to be understood that the washing agent W may be added directly into the washing machine or, if available, via a specific washing-agent (e.g., laundry detergent) dispenser (not shown), as might be provided by the given washing machine 100. It is to be understood, as well, that introduction during the wash cycle 110 would incorporate dispensing of the washing agent W within the water-fill portion of the wash cycle 110 or at some time during the actual washing process. The washing agent W is employed in lieu of a usual laundry detergent, as the washing agent W is used to remove unwanted matter from the clothing and/or gear being cleaned. The washing agent W particularly aids in the removal of unwanted soil, oil, and/or pollutants in preparation for the second step of present process, which is described next.

Per the present embodiment, the cleaning system and method next provides a protective agent P that yields a bonded long-lasting barrier of protection against odors typically associated with bacteria, mold and/or mildew. This protective agent P is introduced during the rinse cycle 130. The protective agent P, in a manner similar to the washing agent W, may be added directly into the washing machine 100 (if available—option typically not available for front-loading washers with an auto-lock feature) or, if available, via a fabric-softener dispenser (not shown), as might be provided by the given washing machine 100. Given that such a fabric-softener dispenser is configured so as to ensure deployment the given dispensed liquid during the rinse cycle 130, the fabric-softener dispenser, like it does for dispensing of fabric softener liquid, also provides a ready-made avenue for timely dispensing of the protective agent P, without the user having to add an additional step midway in the overall washing process (a step that might be otherwise easy to forget and/or, at least mistime).

It is to be understood, as well, that introduction during the rinse cycle 130 would incorporate dispensing of the protective agent P within the water-fill portion of the rinse cycle 130 or at some time during the actual rinsing process. The protective agent P applies a bonded, long-lasting protective coating that resists the adsorption/absorption of staining and odor-causing microbes, such as bacteria, mildew, and/or mold. The second component, in at least some embodiments, additionally can provide anti-static and/or fabric softening properties. The protective agent P may also further incorporate a fragrance, particularly if being used in a variant to be used in washing clothing and/or towels.

The washing agent W may be a detergent/cleaning formulation which, for example, may include non-ionic surfactants, preservatives, chelating agents (which may serve to soften water and/or sequester metal ions), and/or builders (which may act as a softener, buffering agent, and/or emulsifier), among other potential ingredients. It is noted that some additives can fill two such roles, such as citric acid which can act as both a preservative and a chelator, and it is to be understood that such dual-purpose ingredients, where available, are within the scope of the various formulations for either the washing agent W or the protective agent P. Such a first component is able to loosen and aid the removal of a bulk of the pollutants from the fabric, prior to the introduction of the second component in a second stage of the process. Thus, by using a first component of the present system, in the form of the washing agent W, the second component protective agent P is able to be that much more effective when applied in the second stage of the laundering system.

The protective agent P may include a quaternary ammonium antimicrobial (e.g., in the form of a silane and/or a surfactant blend) and may further include other components such as fragrances or enzymes. The quaternary ammonium silane acts as an odor-prevention component, bonding with the fabric and acting to block the adhesion, absorption, and/or adsorption of odor-inducing staining microbes, such as bacteria, mold, and mildew, on the fibers of the fabric (i.e., thus protecting against build-up of such undesired microbes). It is to be understood, however, that any reactive silane chemistry that is able to interact with the fibers of the fabric to yield a durable, non-leaching, microbe-resisting or otherwise antimicrobial surface could be employed and be within the scope of the present system. The protective agent P may further include at least one cationic surfactant, the cationic surfactant being able to aid in the bonding of the quaternary silane to the fabric.

In at least one embodiment, the washing agent W may also further incorporate at least one anti-microbial, similar to the kinds employed with respect to the protective agent P. By introducing anti-microbial components via both the washing agent W and the protective agent P, it effectively serves to give the gear and/or laundry being treated greater exposure to the antimicrobials throughout the full treatment process. Thus, the antimicrobials have a greater chance of bonding with the gear/fabric during a given treatment process than might otherwise be possible if only introduced through the protective agent P. Alternatively or additionally, the antimicrobial in the washing agent W may serve as a preservative, in that it may inhibit the growth of microbes that might otherwise decrease the shelf-life of the washing agent W. That said, it is to be understood that, in some embodiments, the antimicrobial ingredient(s) might be introduced only via the protective agent P, with one example of that scenario being via the application of a renewal spray form of the protective agent P. Such a renewal spray may, for example, be used when there is not time and/or available equipment (e.g., washing machine, sink, etc.) to complete a full clean and protect process.

The washing agent W and/or the protective agent P may further include one or more various enzymes. Such enzymes may serve to break down bacteria, mold, and/or mildew that might already be present in the fabric, thereby helping to eliminate unwanted odors at the source thereof and/or to help achieve a more effective cleaning. These enzymes can also aid in the removal of anionic residues, such as those left behind by ordinary detergents, and various pollutants and stains (e.g., particulate soil, grass stains, oily stains, etc.). Certain enzymes may also act as a softening agent and/or help to reduce the chances of residue from sticking to the fabric (e.g., due to the presence of otherwise residual starches in the fabric). The types of enzymes may, for example, include savanase, amylase, cellulase, lipase, and/or protase. Savanase enzymes, for example, are particularly effective against bacteria.

This cleaning system can be either applied by a hand wash (in a sink in two stages or in a pair of separate containers) or can be used in a washing machine, utilizing both the detergent dispenser and fabric softener dispenser or by manually adding the first part during the wash cycle and the second in the rinse cycle. More broadly, the two-part system is meant to be applied in two separate stages, and any cleaning process that provides for the use of the two components in such a manner would be within the scope of this laundering system/process.

To date, a cleaning process has not been developed that combines together two distinct separate cleaning and protecting methods for performance gear, footwear and apparel. The present cleaning system involves a two-step process that utilizes a premium cleaning agent followed by the application of a long lasting bonded barrier of protection against odors typically associated with bacteria, mold and mildew that additionally provides anti-static and fabric softening properties. The first step removes the unwanted soil, oil and pollutants in preparation for the second step application of a bonded, long lasting protective coating against creation of odor.

In the past the wearer of performance gear, footwear and apparel either utilized topical sprays or general cleaning detergents, which leave no protective coating behind. The reasons these products are ineffective is two-fold. First, these products often utilize fragrances to mask odor. Secondly, these products do not remove odor-causing biofilms that both adsorb and absorb into the synthetic/synthetic blend fibers commonly used to manufacture today's premium performance wear.

When using the present cleaning systems and methods, a user experiences very low odor emission between uses of the cleaning systems and methods. A user experiences an increase in the useful life of gear and apparel through proper cleaning. A user experiences better wicking properties of performance apparel. A user experiences no need for fabric softeners or dryer sheets. A user experiences lower chances of bacterial infection.

In various embodiments, the present cleaning systems and methods include a cleaner (e.g., washing agent W) and a protector (e.g., protective agent P). The cleaner removes unwanted matter from the synthetic/synthetic blend fibers. The protector provides bonded long lasting protection against odor typically associated with bacteria, mold and mildew in addition to provided anti-static and fabric softening capabilities. In an embodiment, the cleaner and protector may be use used in conjunction with one another or in the case of hand washing gear, directly after one another. When using the gear wash (i.e., detergent/cleaner and protector) in a conventional washing machine, the application steps may be combined by the machine's dispensing system or the application steps may be separated by application of the cleaner in the wash cycle and application of the protector in the rinse cycle.

In the past, apparel has been cleaned with typical laundry detergents while gear cleansing and odor protection has been not addressed at all, except for topical spraying with a deodorizer or disinfectant, washed with normal laundry detergents, or masked with a fragrance.

Prior to application of the second-stage odor protection, the cleaning process should be left out ONLY IF the product being treated is brand new. The process can be used on any hard or soft surface to clean and place a protective, bonded barrier against odor typically associated with bacteria and its byproducts.

None of these competitors contain ingredients that leave behind an odor protection coating to provide long lasting protection from odors typically associated with bacteria. Further more OEM anti-microbial applications have been the focus to date, not aftercare reapplication. The present systems and methods are the first to apply this technology as an aftercare solution in the form of a laundry detergent, gear wash, and/or topical spray. The present products and cleaning procedures are designed to meet or exceed the growing need for proper cleaning and verifiable protection of hard and soft surfaces from microbial growth.

Some known competitor treatment agents (in the form of sprays, detergents, etc.) include, but may not be limited to, the following: Penguin Care Sport Wash; Sof Sole Footwear Spray; OdorAid; Monofoil; and Tide Sport.

When possible, the cleaner and protectant of the present disclosure may be used prior to a first use of the performance apparel. The cleaner and protectant may be used regularly in place of a current detergent (e.g., deposited in the washing machine directly or into a detergent dispenser). A second-stage protectant may be added to the user's washing machine's fabric softener dispenser. Either a warm or cold water setting may be used for the washing machine cycle. An advantage of this system is that it tends to be effective at warm or cold water settings, meaning that hot water need not necessarily be used in order to adequately clean the gear and/or other related laundry.

The cleaner and protectant works effectively with all fabrics, not just performance apparel. Athletes and fitness enthusiasts may, for example, like to use it with work-out clothing, towels, and/or undergarments to keep odors from developing.

In various embodiments, the cleaning systems and methods of the present disclosure may be used with a machine wash. This may include following the manufacturer's recommended cleaning instructions on the gear label. In an embodiment, the user may pour 3 oz (where oz is the abbreviation for ounces) of the cleaner component in the washing machine's detergent receptacle. Next, the user may pour 3 oz of the protector component in the washing machine's fabric softener receptacle. These steps may be followed by washing on a medium or normal setting with warm or cold water. This may be followed by air-drying or drying in a dryer (not shown) on a low-heat setting. While 3 oz amounts might be the nominally recommended amounts for any of the various embodiments, it is to be understood that other amounts could be added based on, by way of example only, such factors as the level of cleaning/protection desired, the amount of gear/clothing being treated/wash-load size, manufacturer's guidelines (e.g., if a washing machine is being used), etc.

In one exemplary embodiment, a set of hand wash instruction may include a “Clean Plus Gear Renew” cleaning agent involving a step to pour 3 oz of Clean+ Gear Renew cleaning agent in a bucket with, e.g., five gallons of water or another amount of water sufficient to facilitate hand-washing. A next step involves thoroughly soaking the entire item and scrubbing as needed for at least two minutes. Another step involves squeezing out excess solution. A next step is to treat the item with Protect+ Gear Shield protective agent. There may also be a step to wash off excess soil prior to using Clean+ Gear Renew cleaning agent. Additionally, testing for color-fastness prior to first use is recommended.

In one exemplary embodiment, a protect and gear shield protectant may involve a step of pouring 3 oz of Protect+ Gear Shield protectant in a bucket with, e.g., five gallons of water or another amount of water sufficient to facilitate hand-washing. A step may be provided to thoroughly soak the entire item for at least two minutes. A step may be provided to squeeze out excess solution. The cleaning systems and methods may include air-drying or drying in a dryer (not shown) on a low heat setting.

It is to be understood that, in instances where the odors within the gear, towels, clothing, etc., are particularly well-developed, it may take a multiple washings for odors to be completely removed from the item.

In one example (as sold under the trade name of HEX Power+ Laundry Detergent), the cleaning system may include the following general ingredients: water; at least one builder/chelator/preservative; one or more non-ionic surfactants; an antimicrobial organofunctional silane; one or more enzymes; and a thickener for surfactant-based systems.

In a second example (as sold under the trade name of HEX Ultra+ Dual Action Gear Wash), the cleaning fluid may generally include water; one or more chelating/water softening/preserving agents; one or more non-ionic surfactants; and an antimicrobial quaternary ammonium surfactant blend.

In yet a third example (as sold under the trade name of HEX On Demand+ Spray & Go), the cleaning fluid contains water; at least one non-ionic surfactant; and a plurality of ammonium-based antimicrobials.

In an even further fourth example (sold under the trade name HEX Clean+ Gear Renew), this fabric treatment/protectant solution includes water, a non-ionic surfactant, a fabric softener and anti-static agent, and a plurality of ammonium-based antimicrobials.

In yet a fifth example, for apparel, “Power+” laundry detergent is used for cleaning, and “Enhance+” is used for the protector and, for example, may be dispensed through the fabric softener receptacle. One or both of these will have similar components as compared to other detergent and protectant variants, and one or both may further include a fragrance, given that this combination is formulated with the idea of treating, for example, laundry and towels where fragrance may typically desired. Even though fragrance might be included, it is to be understood that the fragrance still is not included simply to mask the presence of odor-generating microbes, as these variants, like the others, provide ingredients that are effective at attacking those at their source and that make it difficult for microbes to live and grow between washes/treatments.

In relation to the above-listed examples, the HEX Power+ Laundry Detergent, HEX Ultra+ Dual Action Gear Wash, HEX On Demand+ Spray & Go, or HEX Enhance+ Performance Booster could particularly be used as the washing agent W in the process outlined above utilizing a given washing machine 100. Likewise, the Enhance+ protector or the HEX Protect+ Gear Shield second-phase treatment agent could be used as the protective agent P in the process outlined above utilizing a given washing machine 100. It is to be understood, further, that any option that is primarily a cleaning fluid could be used as a given washing agent W and that any option that is primarily a protectant (including, e.g., a protectant/fabric softener combination) could be employed as a given protective agent P.

When cleaning gear by hand during the cleanse stage (e.g., employing Clean+ Gear Renew), it should be appreciated that agitation may be a key to successful cleansing so as to best remove any dirt and/or pollutants that might otherwise be strongly adhering to the lattice of the fabric. It is recommended to use a washing machine, when time and facilities permit, because the washing machine is already configured to provide such agitation.

A key benefit of the present system is that the wash or cleaning agent W and the protecting agent P can be employed within a single, standard water-based washing machine 100. Being able to use a single water-based washing machine 100 provides multiple advantages. First of all, it allows performance gear and/or other laundry that can be subject to development of odor-causing microbes to be processed without having to send it out to a special facility (e.g., dry cleaner) and/or without requiring two or more different machines to achieve the washing and protecting steps. Secondly, by being conducive to use in a water-based washing machine 100, the process can be easily carried out on a regular and/or as-needed basis, for example, at home or in a team facility.

A third benefit surrounds the dispensing capabilities of typical water-based washing machines 100, allowing the washing agent W and the protective agent P to be introduced at the beginning of the overall wash process (e.g., at the beginning of the wash cycle 110), thus further simplifying the treatment process. For example, for the washing agent W may be disposed into the main wash receptacle (not shown) of the washing machine 100 and/or, if available, into a laundry detergent receptacle. Likewise, the protective agent P, may be provided in the fabric softener receptacle (not shown) of the washing machine 100), at generally the same time that the washing agent W is provided, without the user having to come back to complete such a step later in the washing process. This simplification of the process is available due to the fact that the washing machine 100 is typically configured to deploy automatically the agent residing in the fabric softener dispenser at the beginning of the rinse cycle 130.

A yet additional advantage of this system is that, if desired, it is simple and safe enough to use in a hand-wash and hand-rinse set-up, again as a water-based system.

While variants of the washing agent W and the protective agent P specifically disclosed herein are in the form of liquid-based mixtures, solutions, and/or suspensions, it is to be understood that it may be possible to provide one or both such agents in powder form, and that such variants would be deemed to be within the scope of the present system.

In general, the washing agent W (also known herein as the detergent, cleaner, or cleaning agent) generally includes a blend of enzymes, surfactants, preservatives, and antimicrobial organosilanes which are used to clean the gear and/or laundry, while the protective agent P generally incorporates a blend of surfactants, preservatives, and antimicrobial organosilanes that protect the gear and/or laundry and that may provide antistatic, softening, and/or odor protecting attributes. As outlined above, the washing agent W and/or the protective agent P may include other ingredients and still fall within the scope of the present system.

Although the above embodiments have been described in language that is specific to certain structures, elements, compositions, and methodological steps, it is to be understood that the technology defined in the appended claims is not necessarily limited to the specific structures, elements, compositions and/or steps described. Rather, the specific aspects and steps are described as forms of implementing the claimed technology. Since many embodiments of the technology can be practiced without departing from the spirit and scope of the invention, the invention resides in the claims hereinafter appended.

What is claimed is:

1. A cleaning system for at least one of high performance textiles, sports gear, and laundry, the cleaning system comprising:
a cleaning agent configured to remove unwanted matter from at least one of the high performance textiles, sports gear, and laundry; and
a protective agent configured to create a bonded barrier of protection against odors from at least one of bacteria, mold and mildew, the protective agent further providing anti-static and fabric softening attributes.

2. The cleaning system of claim 1 wherein the protective agent includes an anti-static component.

3. The cleaning system of claim 1 wherein at least one of the cleaning agent and the protective agent includes an anti-re-soiling component.

4. The cleaning system of claim 1 wherein the cleaning agent is configured to be provided in a first step of a cleaning process to as to remove at least one of unwanted soil, oil, and pollutants.

5. The cleaning system of claim 1 wherein the protective agent is configured to be used in a second step of a cleaning process to provide a bonded, protective coating against odor-causing microbes.

6. The cleaning system of claim 1 wherein at least one of the cleaning agent and the protective agent can be applied as a hand wash.

7. The cleaning system of claim 1 wherein at least one of the cleaning agent and the protective agent is configured to be applied in a water-based washing machine having a detergent dispenser and a fabric softener dispenser, the cleaning agent being configured to be introduced via the detergent dispenser and the protective agent being configured to be introduced via the fabric softener dispenser.

8. The cleaning system of claim 1 wherein the water-based washing machine is configured to provide for at least a wash cycle and a rinse cycle, the detergent dispenser being configured to introduce the cleaning agent during the wash cycle and the fabric softener dispenser being configured to introduce the protective agent during the rinse cycle.

9. The cleaning system of claim 1, wherein the cleaning agent and the protective agent are configured, respectively, to be used in a wash cycle and a rinse cycle of a given single water-based washing machine.

10. The cleaning system of claim 1, wherein the cleaning agent comprises an enzyme, a surfactant, a preservative, and an antimicrobial component, and the protective agent comprises a surfactant, a preservative, and an antimicrobial component.

11. A cleaning process for treating at least one of performance textiles, sports gear, and laundry, the cleaning process comprising:
providing a water-based washing machine, the washing machine being configured to provide at least a wash cycle and a subsequent rinse cycle;
placing at least one of the performance textiles, the sports gear, and the laundry into the washing machine for processing thereby;
introducing a washing agent during the wash cycle, the washing agent being configured to remove unwanted matter from at least one of the high performance textiles, the sports gear, and the laundry; and
introducing a protective agent during the rinse cycle, the protective agent being configured to create a bonded barrier of protection against odors generated by at least one of bacteria, mold, and mildew, the protective agent further providing anti-static and fabric softening attributes.

12. The cleaning process of claim 11, wherein the water-based washing machine includes a detergent dispenser and a fabric softener dispenser, the washing agent being inserted into the detergent dispenser and the protective agent being inserted into the fabric softener dispenser.

13. The cleaning process of claim 11, wherein the washing agent comprises an enzyme, a surfactant, a preservative, and an antimicrobial component, and the protective agent comprises a surfactant, a preservative, and an antimicrobial component.

14. A cleaning system for at least one of high performance textiles, sports gear, and laundry, the cleaning system comprising:
a washing agent configured to remove unwanted matter from at least one of the high performance textiles, sports gear, and laundry; and
a protective agent configured to create a bonded barrier of protection against odors from at least one of bacteria, mold and mildew;
wherein the washing agent and the protective agent are configured to be used in a two-step water-based treatment process in which the washing agent is provided in a given first step of the treatment process and the protective agent is provided in a given subsequent second step of the treatment process.

15. The cleaning system of claim 14, wherein the two-step water-based treatment process is a two-stage hand-wash process.

16. The cleaning system of claim 14, wherein the two-step water-based treatment process is incorporated into the operation of a single given water-based washing machine having at least a wash cycle and a subsequent rinse cycle, the washing agent being configured to be introduced during the wash cycle, the protective agent being configured to be introduced during the rinse cycle.

17. The cleaning process of claim 14, wherein the washing agent comprises an enzyme, a surfactant, a preservative, and an antimicrobial component, and the protective agent comprises a surfactant, a preservative, and an antimicrobial component.

18. The cleaning process of claim 14, wherein the washing agent is configured to remove unwanted matter from all types of fabrics.

19. The cleaning process of claim 14, wherein the protective agent is configured to create a bonded barrier of protection against odors from at least one of bacteria, mold and mildew on all types of fabrics.
